(19) United States
(12) Patent Application Publication
(10) Pub. No.: US 2019/0347915 A1
(43) Pub. Date: Nov. 14, 2019

(54) Large-scale Video Monitoring and Recording System

(71) Applicant: Ching-Ming Lai, Wakefield, MA (US)

(72) Inventor: Ching-Ming Lai, Wakefield, MA (US)

(21) Appl. No.: 15/978,024

(22) Filed: May 11, 2018

(51) Int. Cl. G08B 13/196; H04N 7/18

(52) U.S. Cl. CPC G08B 13/19656; G08B 13/19669; G08B 13/1968; H04N 7/181; G08B 13/19667

(57) ABSTRACT

A large-scale video system is present here for monitoring or surveillance. Multiple webcams are connected to a personal computer as a camera station. One or more computers are connected to multiple camera stations through the local area network as host computers. The camera stations capture video and audio data from the webcams, encode them, store them into disk files, and transmit them to one or more host computers. The host computers are responsible for playing the video and audio data from all camera stations. In addition, multiple computers within the local network or in the Internet are used as external viewers to play video streams from the host computer. Special application software running in the camera stations, the host computers, and the external viewers integrates the system and carries out the performance.

### FIELD OF THE INVENTION

The present invention relates generally to a video monitoring and recording system. The hardware components are common webcams, personal computers, and the computer network infrastructure. This invention relies on application software to integrate the system, capture video and audio, store them to disk files, and distribute them, in order to view both streaming video and audio from webcams at high definition as well as archival recordings.

### BACKGROUND OF THE INVENTION

There are basically two types of video systems used for monitoring or surveillance purposes. It started with closed-circuit television (CCTV) for surveillance in public areas as well as private areas in banks, stores, big buildings, or other areas where security is needed. In recent years, IP camera systems, or called network camera system, became available and more popular for home security as well as other small area surveillance. The CCTV system uses a special camera and other equipment to transmit, store, and display the video data. It may include a large number of cameras in the system. For most private area applications, the video data from these cameras are displayed and visualized in a location close to the cameras. The IP camera system also uses a special camera. In addition, it has the capability to connect to local area network (LAN) with an Internet Protocol (IP) address. It can transmit video data to a remote Internet site. Compared to the CCTV, the IP camera is a decentralized standalone system. The IP camera system is mostly used for home security and other small area surveillance with relatively small number of cameras in the system. Video data can sometimes be stored locally with additional units, but in most cases, the video data is stored in a remote site, or cloud storage.

The advantage of CCTV systems is wide coverage with many cameras in the system with the data being usually stored in the local computer disk. The disadvantage of CCTV is the complexity and high cost of the system. In addition, the remote access and display of the video data is not available. The advantages of IP cameras are a simpler system with lower cost and the capability of displaying the video data remotely. The disadvantage of IP camera is smaller coverage with small number of cameras in the system. In addition, if local data storage is used, it increases the cost and complexity to manage the data. If cloud storage is used, it not only increases the cost but also consumes substantial Internet transmission bandwidth, which can slow down the Internet speed for other usages such as watching movies or playing video games.

The present invention suggests a video monitoring or surveillance system based on existing and commonly used video cameras known as webcams, the common personal computer (PC), and the common network router. The only special component is the application software running in the PC to acquire, encode, decode, store, retrieve, transmit, and retrieve the video and audio data. The application software also renders multiple video frames and mixes audio sounds from multiple webcams simultaneously.

The webcam can only capture video and audio data. It does not have IP address and it cannot connect to the network directly. Instead, it is connected to the PC through one of the USB ports in the PC. Multiple webcams can be connected to the PC. The PC is used to support the webcams. It can be a dedicated PC with reduced hardware components to reduce the cost and physical size. But it is still running with a standard operating system. Such PCs are available and known as Mini-PCs. The application software takes advantage of many powerful and versatile functions provided by the operating system to integrate and perform this video monitor system.

Besides the Mini-PC, there is a host computer in the system. The host computer is a regular PC. It communicates and manages multiple Mini-PCs. It receives live video data or recorded video data from these Mini-PCs and renders the data to display on the screen. The number of webcams displayed on the host computer is the number of Mini-PC times the number of webcams connected to each Mini-PC. In such configuration, the Mini-PC does not use a display and does not need Graphic Process Unit (GPU). In the present invention, multiple host computers can be used for the same set of Mini-PCs. This allows multiple users at different locations to view the videos captured from all webcams in the system.

As mentioned, the hardware components consist of regular PC as the host computers, Mini-PCs, network routers, and webcams. They are consumer goods. The host computer and the multiple Mini-PCs can be installed and set up like setting up multiple PCs in the local network for common home or office usage. The webcam is typically used in Skype and other video conferencing systems. A user can easily build up the video monitor system of this invention and continue to maintain, expand, or upgrade the system without professional help.

Like CCTV, this invention can include many cameras in the system. It can view live videos as well as recorded videos from many cameras across many locations within the local network area. Yet it is far less complex and less costly than the CCTV. It is much easier to install. Of course, CCTV cameras are more sophisticated and it can place the cameras outside the building, which needs extra work for this invention system.

Like the IP camera, this invention can have remote access. The user can view multiple live videos or recorded videos from a remote Internet site simultaneously rendered by the host computer. But unlike the IP camera, this invention uses local storage to keep the Internet transmission bandwidth from being utilized and avoid the service of cloud storage.

The IP camera costs more than the webcam, but it does not need a Mini-PC. Since a Mini-PC can support multiple webcams, the average cost of Mini-PC plus webcams per camera is comparable to an IP camera. The host computer is basically a desktop computer with large screen to display the videos. If the IP camera is configured to display videos on large screen, it might use a desktop computer or equivalent to fulfill the purpose anyway.

The Mini-PC here needs certain computing speed, network speed, and disk space. The host computer also needs certain computing speed and network speed. Higher speed, larger disk space, and lower cost of these computers are more available every year, partly due to the demand for video games and movies. At present, the speed is adequate for practical usage of this invention system. In the future, as the speed continues to increase and the cost continues to reduce, this system can be expanded to a larger system and upgraded to larger video frame size at higher definition.

The application software is far more extensive and complex than prior arts. The application software make use of powerful software libraries provided by a standard operating system. The application software can be continuously improved to enhance the performance. In some areas, the application software upgrade does not require any change in the hardware. For example, the application software can improve detection of motions of interest in the video. It can also provide better tools to reveal and access the video in the recorded files. In other areas, one or more hardware components may need to be upgraded or replaced for the new application software version. For example, if the video quality is upgraded to higher definition, the webcam may have to be replaced by a higher definition model. The Mini-PC and the host computer may also have to be replaced by a faster model to process larger amount of data. But the system configuration remains the same, which allows the user to upgrade the system easily and reliably.

### SUMMARY

This invention suggests a method of building a large video system based on commonly available devices, namely, webcams, personal computers, and network routers. The system relies on creative application software to integrate the system, capture video and audio date, encode and decode them, store them into disk files, and transmit them to multiple video players across the network. This video system is capable of capturing many webcams and displaying the video data from these webcams simultaneous at high definition. This video system offers many advantages over the prior arts of CCTV system and IP camera system. It is also easy to expand and upgrade this video system.

### BRIEF DESCRIPTION OF THE DRAWINGS

FIG. 1 illustrates the components and connections of the video network system with one host computer.

FIG. 2 illustrates the components and connections of the video network system with two host computers.

FIG. 3 illustrates an example of the proposed graphic user interface, which provides concise display of the available video files and the selection of month, day, hour, and minute, when the player is first started without user's selection.

FIG. 4 illustrates an example of the proposed graphic user interface displaying the available video files and the user's selections in month, day, hour, and minute to start a playback session.

FIG. 5 shows an example of the partition and designation of four display windows for play live or recorded videos.

FIG. 6 shows multiple video streams are created to serve multiple external viewers at the LAN locations or at Internet sites.

FIG. 7 shows that by using multicast transmission method, one video stream can serve many external viewers within the LAN locations.

### DETAILED DESCRIPTION

In this invention, webcams are used as the devices to capture video and audio data. Webcams have been used in Skype and other video conferencing applications. Each webcam is connected to a USB port of a computer. A personal computer is used to support multiple webcams and it is called a camera station in this invention. A personal computer is also used to manage multiple camera stations and works as the host computer of this video network system. In addition, one or more personal computer are used as external viewers to receive and play video stream transmitted from the host computer.

The camera station acquires video and audio data from the webcams. Multiple camera stations can be used in the system. The camera station is not responsible for displaying the video image. It is the host computer which receives the video and audio data from all camera stations in the system through the local area network (LAN) and displays the videos captured from all webcams.

In this invention, multiple host computers can be used in the system. Each of these host computers communicates and receives video and audio data from the same set of camera stations. This allows the videos to play at different locations and viewed by different users. Some of them can be dedicated to play live video and some of them can be dedicated to play recorded video files.

The camera station needs adequate computing speed to encode the video and audio data and transmit them to the host computer. It also needs adequate disk space to record the video files. It is preferable to use a standard operating system to facilitate and enhance the operation of the application software. However, the camera station does not need computer accessories such as screen and keyboard. The commonly known Mini-PC can be used as the camera station.

The host computer needs adequate speed to receive and decode the video and audio data from all camera stations. It needs to display the videos from all webcams simultaneously and possibly at different frame sizes. It needs to mix the audio data from all webcams to generate the sound for the speaker. It is also responsible for rendering and streaming the video through the network for external viewers.

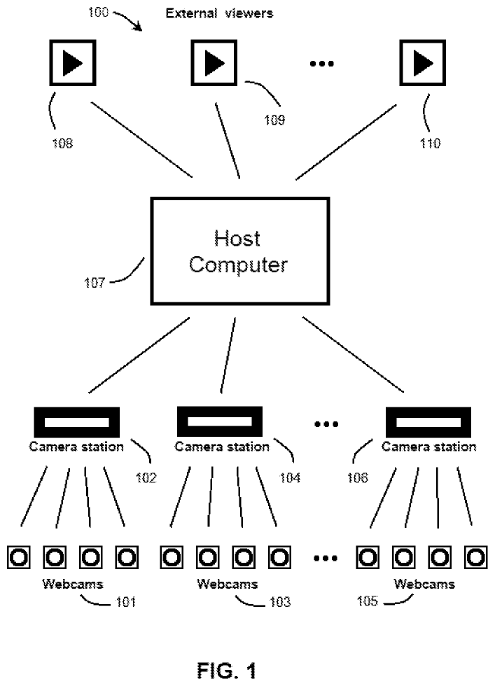

The video network system of this invention with one host computer is illustrated in FIG. 1. In 100, there are multiple camera stations and multiple external viewers. Four webcams in 101 are connected to the USB ports of the first camera station in 102. Another 4 webcams in 103 are connected to the USB ports of the second camera station in 104. Yet another 4 webcams in 105 are connected to another camera station in 106. Each of these camera stations is connected to the host computer in 107 through LAN. The connection between the camera station and the network router can be a wired connection using Ethernet cable or wireless connection by WiFi. The connection between the host computer and the network router can also be a wired connection using Ethernet cable or wireless connection by WiFi. The host computer is also connected to multiple external viewers, shown in 108, 109, and 110, through the LAN or even the Internet.

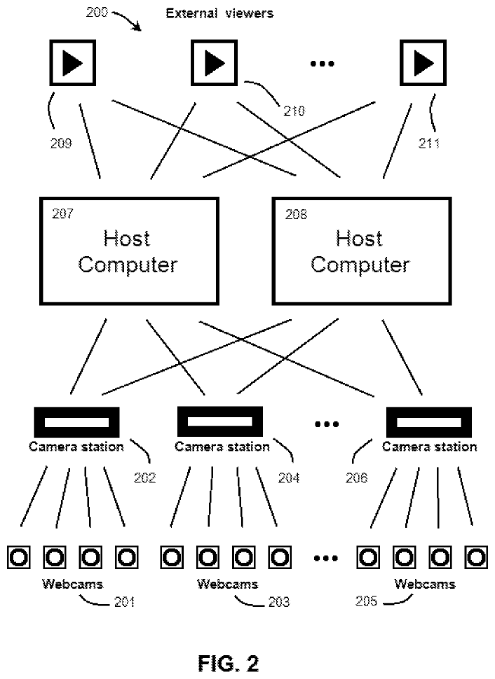

The video network system of this invention with multiple host computers is illustrated in FIG. 2. In the example in 200, there are two host computers with multiple camera stations and multiple external viewers. Like the example of single host computer, 4 webcams in 201 are connected to the USB ports of the first camera station in 202. Another 4 webcams in 203 are connected to the USB ports of the second camera station in 204. Yet another 4 webcams in 205 are connected to another camera station in 206. All of these camera stations are connected to the first host computer in 207 and the second host computer in 208 through the LAN. Both host computers are connected to the external viewers in 209, 210, and 211, through the LAN and possibly the Internet.

This invention makes use of the common infrastructure of a LAN. The local network includes an important device, namely, the network router, to manage the network traffic. Under the LAN, the host computer can communicate with the camera stations, and the camera stations can transmit the video and audio data to the host computer. The operation of the network router also makes it possible for the host computer to stream the video to another site within the LAN or to a remote Internet site.

This invention also makes use the network functions of the operating system software for the host computer to send commands to the camera stations and the camera stations to send video and audio data to the host computer. The operating system software also provides computing functions for this invention to encode and decode the video data at high speed. The application software in this invention has three parts: a program in each of the host computers, a program in each of the camera stations, and a program in each of the external viewers.

The program in the host computer performs three main tasks: (1) making requests to the program in each of the camera stations as a client to send back video and audio data through LAN, (2) decoding the video and audio data, displaying the video data on screen, and mixing the audio data for the speaker, and (3) accepting request from an external viewer in LAN or Internet as a server and streaming out the requesting video and data to the viewer.

The program in the camera station performs two main tasks: (1) capturing video and audio data from the webcams, encoding the data, and storing them into disk as video files, and (2) accepting request from the host computer as a server and sending out the requesting video and audio data to the host computer.

The program in an external viewer performs two main tasks: (1) making requests to the host computer as a client to send back video and audio data through LAN and possibly the Internet, and (2) playing the video and audio for the viewer.

This invention suggests a procedure for the recording of video and audio data. The program in the host computer provides a graphic user interface (GUI) tool for the user to edit a list of recording sessions. Each session specifies the starting time and ending time in a day. The session can be a one-day only session or a daily session. If it is a daily session, then the user can specify one or more weekdays to exclude from the session. There can be more than one session in a day. If some sessions overlap in time, they are automatically merged into one session. The host computer sends this list of recording sessions to selected camera stations, and these camera stations record video and audio data according to the schedule in this list of recording sessions. In this manner, the timings and the lengths of the recording are the same among these camera stations.

This invention further suggests that in each recording session the video and audio data are stored as a series of video files at a constant duration for each file. Preferably, the file duration is one minute and it is synchronized to the computer system clock. When the program in the host computer plays a recorded session, the session's series of video files will be read and displayed sequentially.

This invention also suggests a method to read and play back the recorded video files. The program in the host computer uses operating system functions to copy the video files from the camera stations over the LAN and store them into a local folder as temporary video files. These temporary video files are then read, decoded, and displayed on the screen of the host computer. While one temporary file is playing, the next video file in series is copied ahead to another temporary file such that the transition from one file to the next file can be fast and unnoticeable. In this manner, the programs in the camera stations are not involved in this operation. Therefore, they can continue to perform their tasks without interruption by this operation.

In the camera station, the disk space storing recorded video files keeps growing. Therefore, the program in the camera station checks the disk space periodically, and deletes old video files if necessary to make room for the new video files. This invention suggests that the program also checks the recorded video files periodically and lists the video files that still existing in the disk. This list of video files can be stored into a disk file or stay in the memory for the host computer to read. The host computer reads the lists of video files from all camera stations, and combines them into one list of video files. Based on this list of video files, the host computer provides a means for the user to select and play the video files of interest.

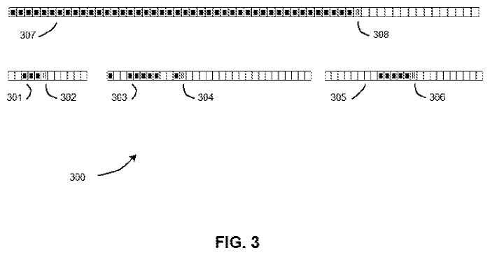

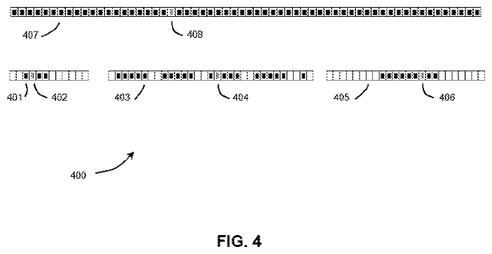

In this invention, a method is suggested to show the availability of the video files and to select the video files of interest to play. Firstly, the list of video files is divided into one or more yearly lists to list the video files for each year separately. The user selects a yearly list to play. A GUI tool is provided for the user to see and play specific video files in time. This tool consists of 12 boxes to mark for the months of the year, 31 boxes to mark for the days, 24 boxes to mark for the hours, and 60 boxes to mark for minutes as shown in FIG. 3 and FIG. 4. If a month has one or more video files in any camera station, it is filled with one color, such as blue. Otherwise, the box is left empty. If the month is selected to play the video files by click the box or by the program, the box is changed to another color, such as red.

When the host computer starts a session to play the video files, the latest yearly list is used. Preferably, the latest video in the yearly list is automatically selected to play. In other words, the most recent video file is played when the player just started without user's input. An example is shown in FIG. 3. In this example in 300, the combined list file indicates that 4 months have at least one video file available and their boxes are filled in 301. The month of June is selected in 302. The row in 303 has 8 days in filled boxes and the last day (which is June 12) is selected in 304. The row in 305 shows 6 hours in June 12 have video files, and the 13^{th} hour (which is 1 PM) is selected in 306. On the top row in 307, the first 44 minutes at 1 PM of June 12 have video files. It shows the most recent file of the list is at 1:44 PM of June 12. It is selected by the program to start the playback in 308.

Now if the user clicks a minute box, the player will stop and play the series of video files starting from that minute. If the user clicks an hour box, the boxes of minutes within that hour that has one or more videos will be marked in blue and the first minute will be automatically selected. The player will stop and play the series of video files starting from that minute. Likewise, the user can click a day box or a month box. The player will stop and play the series of video files starting from the first hour and first minute of the selected day or month. In other words, the recorded videos are randomly accessible for play back.

An example of selecting a specific time to start the playback is illustrated in FIG. 4. In 400, there are 4 months that have video files in 401. The month of April is selected in 402. As the result of the selection, the days of April are shown in 403, which indicates every weekday except Saturday and Sunday has video files. The user selects April 17 in 404, and the hours of that day are shown in 405. The user further selects the 15^{th} hour of that day (which is 2 PM) in 406, and the minutes are shown in the top row 407. In this example, the user selects 21^{st} minute of that hour in 408, which is 2:20 PM, to start the playback. The host computer will play the list of files starting from 2:20 PM of April 17. The player will continue to play the sequence in the rest of the list until the user stops the player or selects another time to play.

The video network system can have many webcams from multiple camera stations. Although the host computer can have two or more display screens, the screen space is still limited. In order to display the videos from many webcams simultaneously, some of the videos have to be reduced to smaller frame size. This invention suggests a method to accommodate large number of videos and still be able to visualize the video of interest in full resolution.

In this invention, multiple windows are provided to display for live videos and another multiple windows are provided to display for recorded video files. Assume the full size of the video frame has 1280×720 pixels. The video frame will have 640×360 pixels at half size and 320×180 pixels at quarter size. Each window can be used to display one full-size video, 4 half-size videos, or 16 quarter-size videos. A GUI tool is provided for the user to partition the full-size rectangle area into 4 half-size rectangles and partition each half-size rectangle to 4 quarter-size rectangles. The tool further allows the user to designate each rectangle, whether it is a full size, half size, or quarter size, to display for a selected camera station and a selected webcam in that camera station.

Notice that in this method, a window can be partitioned to have half-size rectangles mixed with quarter-size rectangles. This allows the user to select different frame sizes to display for different videos of interest. In any case, when a half-size rectangle or a quarter-size rectangle is clicked, another window will pop up to display the underneath video in full-size rectangle. In this manner, the user can select the frame size for each video such that all videos are visible in one of the multiple windows, and each video can be zoom up to full size in a separate window for detail viewing at high definition.

If some of the rectangles in a window is not designated to a webcam, the window may be larger than the area of the designated rectangles. In this case, the window will be automatically reduced to a smaller size such that it only contains the designated rectangles. This saves the usage of the screen space.

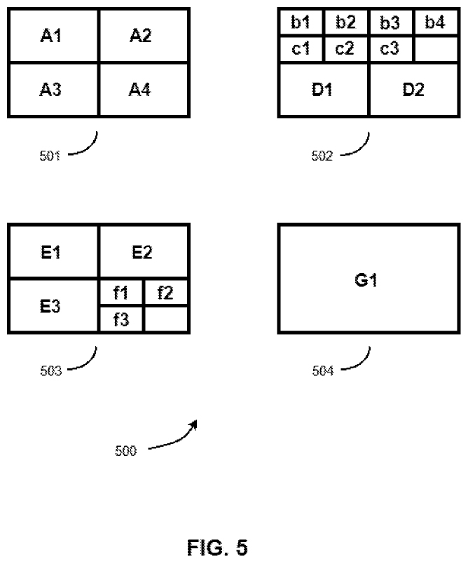

The partition of the display window GUI is further illustrated in FIG. 5. In this example there are 4 windows in 500 for displaying live or recorded videos. In 501, window 1 is partitioned and designated to webcam 1, 2, 3, and 4 of camera station-A at half size. Likewise, In 502, window 2 is partitioned and designated to display for 4 webcams of camera station-B and 3 webcams of camera station-C at quarter size. It is also partitioned and designated to display for webcams 1 and 2 of camera station-D at half size. In 503, window 3 is partitioned and designated to display for 3 webcams of camera station-E at half size, as well as 3 webcams of camera station-F at quarter size. In 504, window 4 is dedicated and designated to display for webcam 1 of camera station-G at full size.

As mentioned earlier, this video network system also includes one or more external viewers. They play the video data received from the host computer. Each of them is running in a personal computer in another location within the LAN or anywhere in the Internet, and thus called an external viewer. These external viewers allow the host computer to distribute the videos to more viewers.

This invention suggests the partitioned and designated window is also used for the external viewers. In this approach, the external viewer requests the host computer to send video data as specified by one of partitioned and designated windows. If this window is not displaying at this time, the host computer decodes and plays the videos from the camera stations according to the partition and designation of this window. The host computer then treats the videos within the whole window as one full-size video. The host computer encodes the full-size video and streams the encoded data to the external viewer. In this manner, the external viewer can display multiple videos from multiple webcams in one full-size window.

The host computer can stream the video data by the standard network control protocols HTTP or RTSP (Real Time Streaming Protocol). It is preferred to stream the video by RTSP. There are standalone player available to receive and play the streaming video. This invention suggests that the external viewer incorporate a well-known and popular video player, such as VLC player. In this approach, the external viewer requests the host computer for RTSP video stream. It then passes the Internet address of the host computer at a predetermined network port number to the VLC player and invokes the VLC to receive and play the video stream.

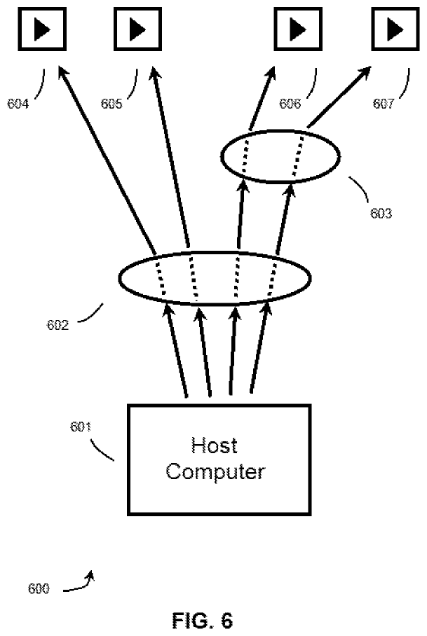

Multiple external viewers can access the host computer at the same time at Internet sites. But the host computer has to create and deliver separate video stream for each external viewer. This takes substantial computing power from the host computer. Thus, there is a limit for the number of external viewers to be playing at the same time. This is shown in FIG. 6. In 600, the host computer in 601 has to create 4 separate video/audio streams in order to serve 4 external viewers in this example. All these streams transmit through the LAN in 602. Two of them transmit to an external viewer 604 and another external viewer 605, both located within the LAN. The other two streams transmit further to the Internet network in 603 before reaching external viewers 606 and 607, located at remote sites in the Internet.

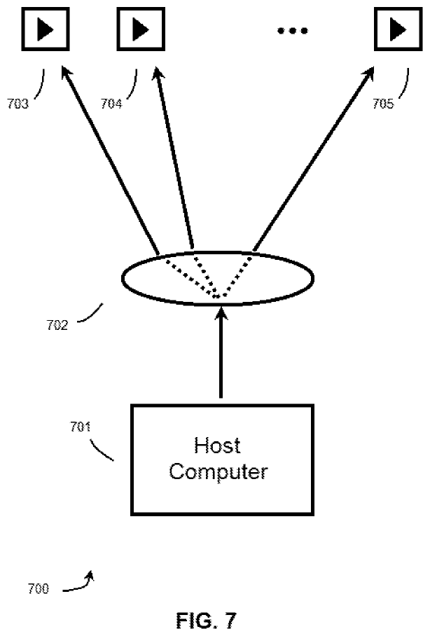

There is a network technology known as multicasting. Using that technology, the host computer can send the video to many external viewers with one video stream only. The technology makes use of the network router's capability to replicate the video stream along the network paths. However, this technology is usually applicable only within the LAN. In this approach, the host computer uses a dedicated network port number to send out the video stream in multicasting mode. Many external viewers located within the same LAN can use this network port number to receive and play the video stream. This is very useful for many people in an organization to watch the same video from the same host computer. This is shown in FIG. 7. In 700, the host computer in 701 creates only one video/audio stream to serve many viewers within the LAN locations. Using the multicasting transmission method, the stream is replicated by the routers of the LAN in 702. These replicated streams are them transmitted to many external viewers in 703, 704, and 705, all located within the LAN.

Some mobile devices, such as iPhone, may use special network communication protocol to receive video stream. The host computer can prepare and send the video stream according to the specified protocol. This invention suggests that the mobile device requests for one of the partitioned and designated windows in the host computer. The host computer then decodes and plays the videos from the webcams according to the partition and designation of this window. The host computer then encodes the whole window as one video and streams it to the mobile device. In this manner, the mobile device can view multiple videos from multiple webcams on the full-size screen.

In this invention, the camera station captures video data from the webcam frame by frame, as described above. After capturing a video frame, the camera station encodes and appends the video frame to the disk file. The camera station may also send the encoded frame to the host computer for display. The camera station then requests the webcam for the next frame. The webcam is set to deliver video data at a maximum frame rate of say 30 frames per second. If the camera station delays the request for the next frame, the frame rate will decrease. It should be noted the camera station delivers audio data independent of the video data. The amount of audio data is much less than the video data and it can be neglected in the usage of computing power.

Another embodiment of the invention is that when the camera station does not have the sufficient computing speed to complete the capture and processing of video frames the camera station will reduce the video frame rate. In that case, the live video, as well as the recoded video files, have video frame rate less than 30 frames per second. The video will be played at the reduced frame rate, but still has the same high definition. This allows the camera station to have fluctuating or insufficient computing power for the video system. More importantly, as the frame rate is reduced, the host computer needs less computing power to process videos from all camera stations. Thus, one way to incorporate more camera stations in the video system with limited host computer speed is reducing the video frame rate in every camera station. In this manner, the host computer can keep up the rate to process and display the videos from larger number of webcams.

In the description above, the camera station captures, encodes, and stores the video frame in high definition of say 1280×720 pixels (i.e. 720p). It also sends the same encoded video frame to the host computer in high definition. The host computer then decodes the full-size video frame and reduces the size of the decoded frame to fit the partitioned window.

Another embodiment of this invention is that the camera stations capture, encode, and store the video frames in high definition, but it also encodes the video frames at half definition of 640×360 pixels and sends the half-size video frames to the host computer. In this manner, the video data for the host computer to process and display on the partitioned and designated windows is reduced by a factor of 4. In principle, the number of webcams that the host computer can process and display for them is increased by a factor of 4. Of course, there is a drawback in this approach. One of the video frames in the partitioned and designated window may pop up to display full-size video frame. The camera station has to deliver a full-size video frame or the host computer has to zoom up the half-size video frame to full size for the pop-up window.

In another embodiment, when a GPS device is installed near the camera station, the program in the camera station reads the GPS location text at certain time intervals from the GPS software either directly or indirectly. These locations are treated as a text stream. The text stream is then merged with the video data and audio data and stored into the video file. When the video file is played back, the location name is displayed like a subtitle of a video. This feature is useful when the camera station is installed in a moving vehicle.

Compared to prior, the present invention is clearly different from CCTV. Unlike the common webcam in this invention, the camera in CCTV is more specialized. It generally delivers video frame directly to a host computer. Special circuit card is needed in the host computer to capture the video data. The computer system network between the camera and the host computer is not used in CCTV. The IP camera, also called network camera, is also more complex than the common webcam. It contains circuitry to communicate and connect directly with the LAN. It also encodes the video data and may include motion detection circuitry. Some of them encode the video frames as JPEG images to simplify the computation and data transfer. In that case, the video is played out more like a series of slides instead of movie-like video.

Some of prior arts may use PC in the video system for purpose other than display the videos, but the PC is not used as the camera station supporting multiple webcams in this invention. For example, U.S. Pat. No. 5,903,261, “Computer based Video System”, uses a video capture card in a PC to digitize analog video signal from a camera or VCR and compress the digitized video data. In the patent of U.S. Pat. No. 7,116,357 B1, “Camera Monitoring System”, one or more computers are used. Each computer controls and receives only one video signal from one of the video cameras selected by the user. A video board is included in the computer to digitize the video signal, display, and distributes the digitized data. It is a CCTV system. The patent of U.S. Pat. No. 7,310,111 B2, “Video Monitoring and Security System”, suggests a computerized video system based on a standard PC platform. It is also a CCTV system, as the video cameras are connected to a special card in the PC to digitize the analog video signal and send the digitized data to the PC. When motion is detected, it compresses the video signal into JPEG images and distributes the JPEG images through the network. The patent of U.S. Pat. No. 6,323,897 B1, “Network Surveillance Video Camera System”, uses one or more video cameras. Each camera is basically an IP camera with network communication circuitry, JPEG encoder and motion detector. The patent of U.S. Pat. No. 6,970,183 B1, “Multimedia Surveillance and Monitoring System Including Network Configuration”, is also an IP camera based system where each camera connects directly to the network router.

This invention is intended to build a large video system with many video cameras, and capture, record, and display the video data in high definition of at least 720p. As described above, it needs substantial computing power in the camera stations and the host computer. It also needs sufficient speed in the network router to deliver a large amount of video data from the camera stations to the host computer. Each of the camera stations also needs large disk space to store the large amount of video data. It was not feasible or not practical until recent years.

In the recent years, the common PC speed is largely increased, partly driven by the demand and requirements of movies and video games. In addition, the common PC has a hardware video encoder chip embedded in its CPU, which makes the video encoding and decoding much faster. In the meantime, the cost of PCs and disk drives continue to drop. The concept of this invention might have been suggested before. But it would be under different context as such system would not be feasible or cost too much to be practical until recent time.

At present, a system consists of 4 camera stations with 4 webcams in each station has been tested with both wired and wireless connections in satisfactory performance. The router meets 802.11ac standard and has three bands (2.4 and 5 GHz) for WiFi. Each camera station is a Mini-PC based on Intel Core i5 7400 CPU with 4 TB disk space. The host computer is a desktop PC based on Intel Core i7 7700 CPU to decode and display live videos and recoded videos simultaneously from these 16 webcams at high definition of 1280×720 pixels. If the camera stations reduce the video frame rate from the average of about 25 frames per second to about 12 frames per second as suggested in one embodiment, the host computer should be able to decode and display for 32 webcams. If the camera stations encode and send the video frames at half size for the host computer as suggested in another embodiment, the host computer should be able to decode and display for 64 webcams.

What is claimed is:

1. A video network system comprising:
multiple webcams as the video and audio capture devices; and
multiple personal computers as the camera stations wherein each of the camera stations is connected with multiple webcams; and
one or more personal computers as the host computers wherein each of the host computers communicates with the camera stations in the system and play out the video and audio data captured or recorded from the webcams; and
one or more personal computers as external viewers to play out video and audio received from a host computer; and
one or more network routers which connect the camera stations and the host computers to the same local network by wired or wireless connection; and
a set of application software to process the video and audio data and to communicate and transfer data between the host computer and the camera stations and between the host computer and the external viewers.

2. The said application software in claim 1 runs in the camera station to perform tasks comprising:
capturing the video and audio data from the webcams, encoding the video and audio data, and storing them into disk as video files; and
accepting and processing requests from the host computer as the server and sending out the requesting video and audio data to the requesting host computer.

3. The said application software in claim 1 runs in the host computer to perform tasks comprising:
making request to the camera stations as a client to receive video and audio data through the local network; and
decoding the video and audio data, rendering the decoded video data to display on screen, and mixing the audio data for the speaker; and
accepting and processing requests from the external viewer and streaming out the requesting video and audio data to the requesting viewer.

4. The said application software in claim 1 runs in the external viewer to perform tasks comprising:
making requests to the host computer as a client to receive video and audio data through the network; and
playing back the received video and audio data.

5. A method of scheduling the recording of video and audio onto camera station disk comprising:
a list of recording sessions for the camera station to execute, wherein each session specifies the starting time and ending time of a day; and
a session can be a one-day only event or a daily event; and
a daily session can exclude one of more weekdays.

6. The said host computer in claim 1 prepares the said list of recording sessions in claim 5 and sends the list of recording sessions to selected camera stations, and the camera stations record video and audio data according to this list of recording sessions.

7. In the said recording session in claim 6, the video and audio data are recorded as a series of video files with a constant duration of preferably one minute in each video file and synchronized with the computer system clock every minute.

8. The said host computer in claim 1 uses operating system functions to copy the video files stored in the said camera stations in claim 1 through local area network into local folder as temporary files and playback the recorded video and audio data from these temporary files.

9. In the said copy operation in claim 8, the next video file in the sequence is copied from the said camera station in claim 1 ahead of its playing time to another temporary file such that the transition time for the host computer to play from one video file to the next video file is minimized.

10. The said camera station in claim 1 prepares the list of the recorded and still existing video files in the disk periodically and writes the list to a disk file or stores the list in memory for the said host computer in claim 1 to read and combine the lists from all camera stations into one list of video files.

11. A method of showing the existing recorded video files and selecting the video files of interest to play comprising:
a row of 12 boxes to mark for the months wherein the months have one or more video files are filled with one color such as blue and the month selected to play is filled with another color such as red; and
a row of 31 boxes to mark for the days wherein the days have one or more video files under the selected month are filled with one color and the day selected to play is filled with another color; and
a row of 24 boxes to mark for the hours wherein the hours have one or more video files under the selected month and day are filled with one color and the hour selected to play is filled with another color; and
a row of 60 boxes to mark for the minutes wherein the minutes have video file under the selected month, day and hour are filled with one color and the minute selected to play is filled with another color; and
when a month, a day, or an hour is selected by the user or the program, the program starts to play the earliest video files of the selected month, day, or hour; and
when a minute box is selected by the user or the program, the program starts to play the video file of that minute; and
the program continues to play the series of video files and mark the selected month, day, hour, and minute boxes accordingly.

12. The operation of the said method in claim 11 follows the rules comprising:
when a month box is selected by the user or by the program, the first day that has one or more video files is selected; and
when a day box is selected by the user or by the program, the first hour that has one or more video files is selected; and
when an hour box is selected by the user or by the program, the first minute that has video file is selected to play.

13. A method of display many videos simultaneously from many webcams comprising:
multiple windows to display for live videos and separate multiple windows to display for recorded videos wherein each window can display a video at full size; and
the full-size rectangle in each window can be partitioned to four rectangles at half size and the half-size rectangle can be further partitioned to four rectangles at quarter size; and
each rectangle at full size, half size, or quarter size, can be designated to display for the video from a specific webcam; and
the video from a specific webcam is decoded and displayed on the designated rectangle at the partitioned size.

14. When the videos are playing on the said window in claim 13, the user can click on any one of the said half-size rectangles or the said quarter-size rectangles in claim 13, and a full-size window will pop up to display the video designated to that rectangle at full size.

15. The videos displayed on the said partitioned and designated window in claim 13 is encoded as one video at full size and stream to one or more of the said external viewers in claim 1.

16. The said video in claim 15 is streaming under a standard network protocol such as RTSP, and a standalone video player in incorporated into the said external viewer in claim 1 to receive and play the video stream.

17. The said video in claim 15 is streaming to many of the said external viewers in claim 1 at the same time using the multicasting transmission method.

18. The videos displayed on the said partitioned and designated window in claim 13 is encoded as one video at full size and streams to a mobile device under the network transmission protocol specified by the mobile device.

19. The said application software in claim 2 reduces the video frame rate in capturing the video data from the webcams to allow the said host computer in claim 1 to process and display videos for more webcams.

20. The said application software in claim 2 captures, encodes, and stores the video frame in high definition, but it also encodes and sends to the host computer the video frame in half definition to allow the said host computer in claim 1 to process and display videos for much more webcams.

21. The said application software in claim 2 also reads the location name generated by GPS device software at a regular time interval as a text stream and adds the text stream to the video file.
